(19) United States
(12) Patent Application Publication
(10) Pub. No.: US 2009/0037232 A1
(43) Pub. Date: Feb. 5, 2009

(54) Loans Collateralized by Life Insurance Policies

(75) Inventors: Alexander A. Dubitsky, Larchmont, NY (US); Rebecca Fein, New York, NY (US); Charles McGarraugh, Brooklyn, NY (US); Samuel Ramos, Manhasset, NY (US)

Correspondence Address: LEE & HAYES, PLLC, 601 W. RIVERSIDE AVE., SUITE 1400, SPOKANE, WA, 99201, US

(73) Assignee: GOLDMAN, SACHS & CO., New York, NY (US)

(21) Appl. No.: 12/182,600

(22) Filed: Jul. 30, 2008

Related U.S. Application Data
(60) Provisional application No. 60/952,829, filed on Jul. 30, 2007.
(60) Provisional application No. 61/037,995, filed on Mar. 19, 2008.

(51) Int. Cl. G06Q 40/00

(52) U.S. Cl. 705/4

(57) ABSTRACT

This document describes techniques pertaining to loans collateralized by life insurance policies.

### RELATED APPLICATIONS

This application claims the benefit of U.S. Provisional Application No. 60/952,829 filed on Jul. 30, 2007 and U.S. Provisional Application No. 61/037,995 filed on Mar. 19, 2008, both of which are incorporated by reference herein in their entirety.

### SUMMARY

This document describes techniques pertaining to loans collateralized by life insurance policies. Some implementations further offer interest rate buy downs for the collateralized loans. In one case, a system includes a rate calculation module for calculating an interest rate for a loan collateralized by a life insurance policy and for calculating at least one alternative interest rate for an instance where a lump sum is paid on the loan. The system also includes a presentation module for formatting the interest rate and the alternative interest rate for presentation to a borrower.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, and/or any other subject matter consistent with the context above and throughout the document.

### BRIEF DESCRIPTION OF THE DRAWINGS

FIGS. 1-4 illustrate exemplary systems for implementing a loan collateralized by a life insurance policy.

FIG. 5 illustrates an exemplary flow diagram for implementing a loan collateralized by a life insurance policy.

### DETAILED DISCUSSION

Overview

This document describes techniques for implementing a loan collateralized by a life insurance policy. In some cases, an individual takes out the life insurance policy from an institution or provider and the loan from the lender. In such cases, the individual can be thought of as the “insured” individual and is the “policy holder” in relation to the life insurance policy. Further, the individual can be thought of as the “borrower” in relation to the loan. Other entities may assume one or more of these roles in other scenarios. For instance, in some cases the individual establishes a life insurance trust. The life insurance trust can then act as the policy holder and/or the borrower. The borrower finds the loan attractive due to increased liquidity, among other benefits. On the other hand, potential lenders find the collateralized loan attractive because of the security of the collateral offered by the life insurance policy, among other benefits.

The borrower receives a predetermined amount of money as defined by the loan (i.e., “principle”) and in return agrees to pay back the principle plus an agreed upon amount of interest. In the event that the loan is not repaid during the life of the individual, then the lender can claim any unpaid balance from the proceeds of the life insurance policy. The present concepts offer flexibility in how the borrower repays the collateralized loan. For instance, some implementations allow the borrower to buy down a rate of the interest on the loan. For example, the borrower can pay a lump sum to decrease or eliminate the interest rate for a portion of, or an entire duration of, the loan. The rate buy down feature offers a financial planning tool that was otherwise unavailable to the borrower.

In some instances the collateralized loan can be utilized to satisfy the conditions of the life insurance policy (i.e., to pay the insurance premiums). In these cases the collateralized loan can be thought of as a premium finance loan to finance the ongoing premiums or payments to keep the life insurance policy in good standing. The rate buy down feature can offer asset management options to the borrower that are otherwise unavailable. For instance, the borrower can utilize the premium finance loan to pay the premiums on the life insurance policy. The borrower can then utilize a lump sum to buy down the interest rate of the premium finance loan. The buy down feature enables the individual to decrease the future cash flow required to make the payments on the premium finance loan.

Exemplary Systems

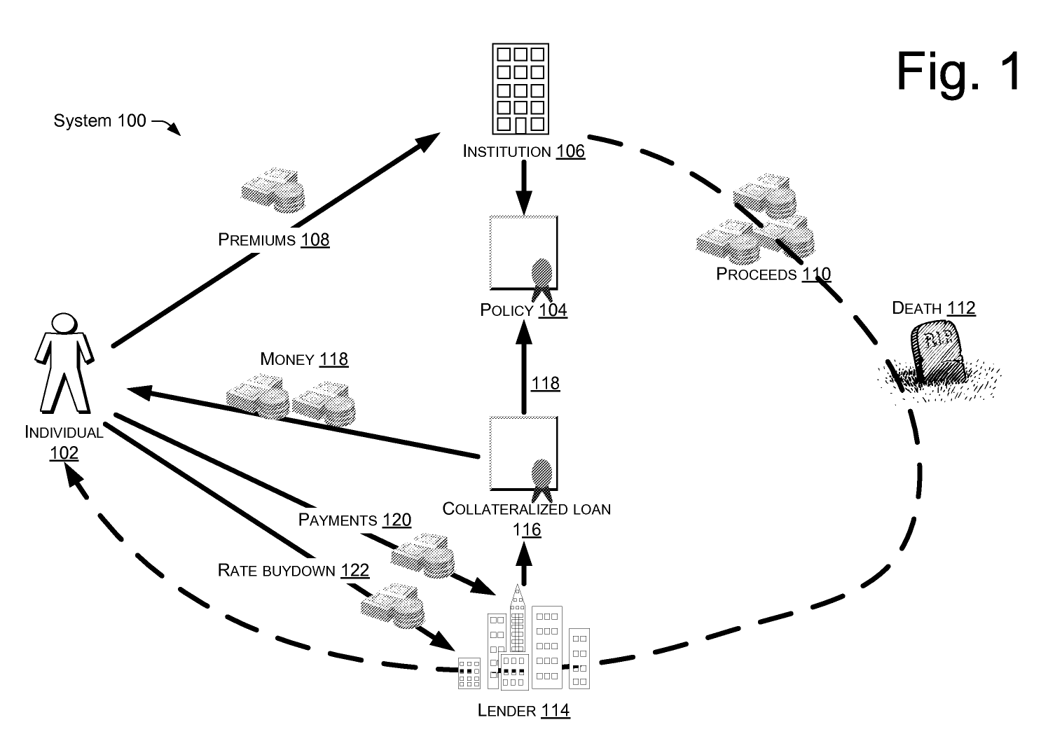

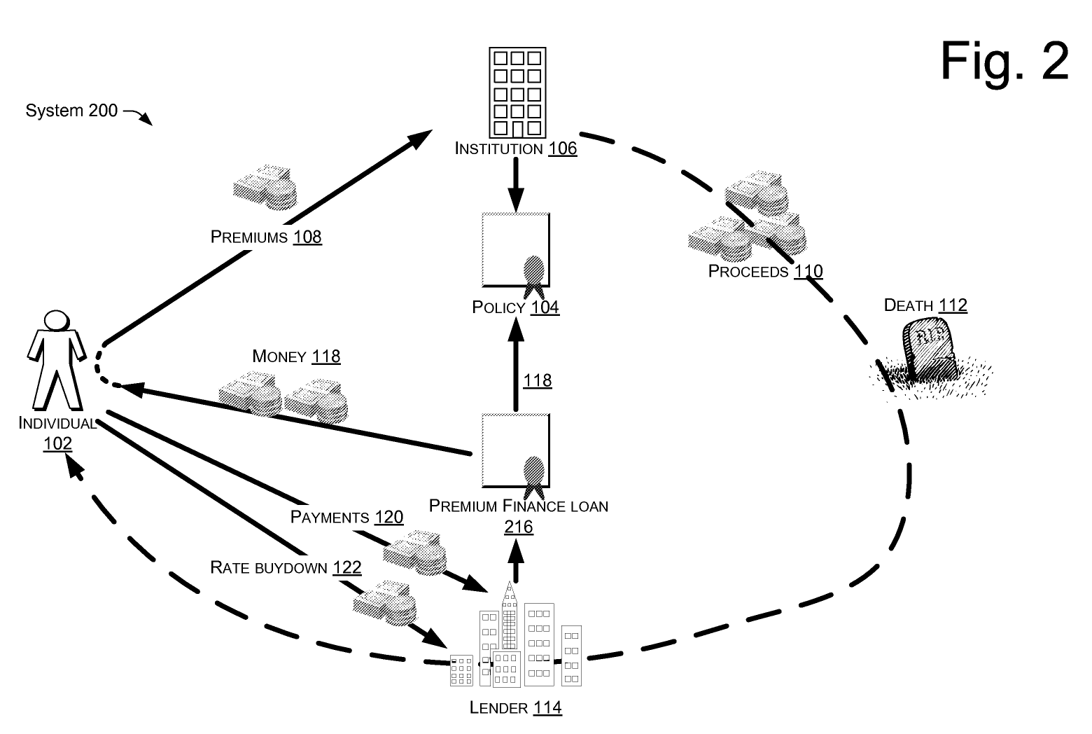

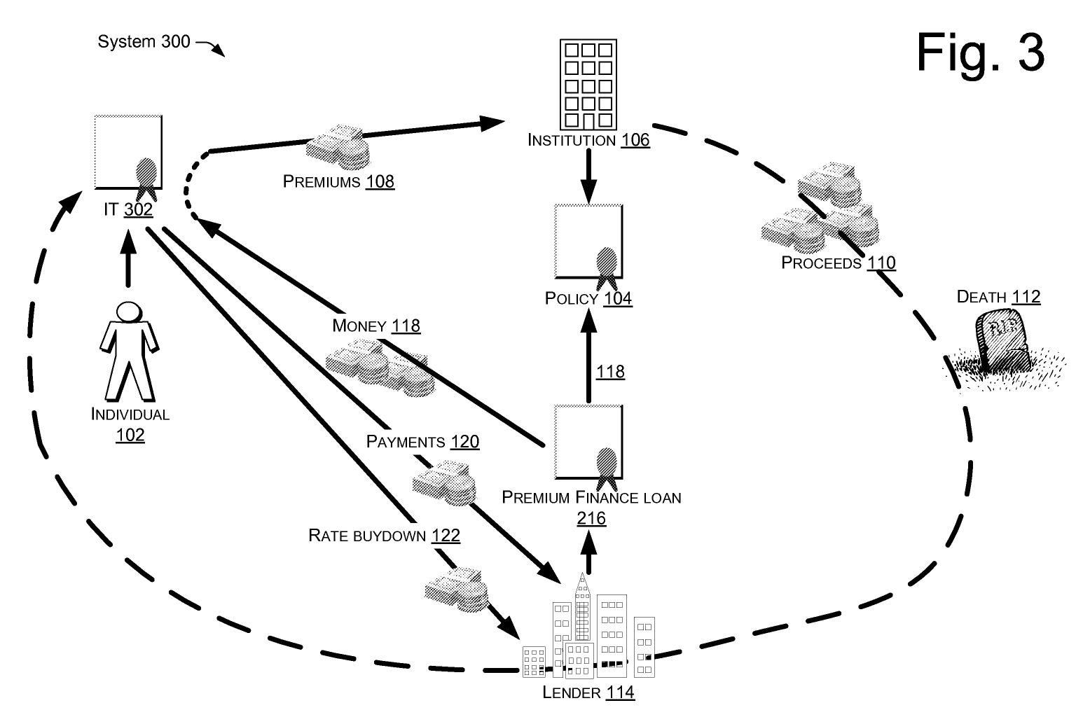

FIGS. 1-3 collectively describe concepts relating to loans collateralized by a life insurance policy. FIG. 1 offers a general introduction to the concepts, while FIGS. 2-3 relate to specific implementations associated with the concepts.

FIG. 1 shows a system 100 that includes an individual 102 that contracts for a life insurance policy 104 with an institution 106 such as an insurance provider. Life insurance policy 104 contains conditions for both the individual 102 and the institution 106. For instance, the individual is required to maintain the life insurance policy via payment of periodic premiums 108. Similarly, the life insurance policy 104 specifies a payout of proceeds 110 that will be made by the insurance provider to the individual (i.e., the individual's estate) upon the occurrence of specified conditions including death 112 of the individual 102.

System 100 also enables individual 102 to take out a loan from an institution or lender 114. Lender 114 may be the same or a different entity as the institution 106 that issued the life insurance policy 104. In this instance, the loan is a collateralized loan 116 that is collateralized by the life insurance policy as indicated at 118. Collateralized loan 116 is collateralized in that some or all of payout 110 that was otherwise destined for the individual's estate can ultimately be delivered to the institution 114 to satisfy collateralized loan 116. (For simplicity of explanation, proceeds 110 are illustrated passing through lender 114, when in fact, the collateralized loan 116 simply gives the lender 114 a security interest in the proceeds 110.)

In exchange for the liquid assets, such as money 118 made available by collateralized loan 116, individual 102 has to make periodic loan payments 120 in the future to cover the collateralized loan. The payments 120 generally cover the loan amount (i.e., principal) and a specified rate of interest. System 100 can offer still another feature in that individual 102 can buy down the interest rate associated with collateralized loan 116 as indicated at 122. For instance, assume that collateralized loan 116 is for x dollars such that individual 102 is required to pay back x dollars plus a given interest rate, such as eight percent with the periodic loan payments 118. The rate buy down feature 122 allows the individual to pay a lump sum to decrease and/or eliminate the interest rate component of payment 120 on the collateralized loan 116. Continuing with the above example, individual 102 can pay a lump sum to decrease the interest rate for the life of collateralized loan 116. For instance, in one hypothetical example, the lump sum can be used to decrease the interest from eight percent to four percent. In another example, the lump sum may be utilized to eliminate the interest for some predetermined period or all of the duration of the collateralized loan 116 (e.g., from ten percent to zero percent). Other examples of the rate buy down feature 122 are described below. In summary, the rate buy down feature allows the individual to avoid or reduce periodic interest components of payments 120 by paying a lump sum up front.

Various tools are available to lender 114 in exchange for offering collateralized loan 116 with its rate buy down feature 122. For instance, initially, the institution can charge an arrangement fee on the loan. An arrangement fee is an upfront charge on a loan commitment. The lender can offer the option to capitalize or defer the arrangement fee. The arrangement fee can be based upon the principal for the expected term of the loan.

In other cases, the lender 114 can charge for initially and/or periodically verifying the existence and status of the life insurance policy 104. Similarly, the lender can monitor the value of the life insurance policy. For instance, the value may be tied to various indices that cause the value to vary over time. In some cases, the lender can request additional collateral if the value falls below a predetermined variation margin. The lender can retain the right to place the loan in default in an instance where the requested additional collateral is not received within a predefined period. In some cases, the lender can choose to increase the interest rate in at least some predefined instances where the loan is in default. Exemptions to the increased interest rates may be made where the default is attributable to the bankruptcy of the individual 102. Pre-payment penalties may still be applied where the borrower (i.e., individual 102) subsequently repays the defaulted collateralized loan 116. In a similar vein, the lender can charge for foreclosure costs and expenses in the event of a default.

FIG. 2 shows a system 200 that builds upon the life insurance policy loan collateralization introduced above in relation to FIG. 1. In this case, the collateralized loan 116 of FIG. 1 is implemented as a premium finance loan 216. The premium finance loan 216 provides money 118 for paying the periodic premiums 108 defined in the life insurance policy 104. In return for the premium finance loan 216 covering the periodic premiums 108, the individual is required to make periodic loan payments 120 to repay the premium finance loan. In some instances, periodic loan payments 120 can be based upon the amount of the premium finance loan and an associated interest rate of the premium finance loan. The premium finance loan is collateralized (up to 100%) by the life insurance policy death benefits or proceeds 110. To this end the policy 104 can be collaterally assigned to the lender 114 so that the policy value (i.e., proceeds 110) is available to the lender as collateral.

System 200 can further enable the individual 102 to buy down some, or all, of the interest portion of periodic loan payments 120 utilizing the rate buy down feature 122. Accordingly, the premium finance loan 216 in combination with the rate buy down feature 122 can allow the individual to control the timing and/or amount of his/her cash outlays associated with maintaining life insurance policy 104. For instance, such a scenario can allow the individual to supplant his/her cash flow related to paying the insurance premiums 108. Stated another way, the individual's cash flow requirements are lessened by utilizing premium finance loan 216 to pay the life insurance premiums 108. In another scenario, individual 102 can utilize available liquid assets to buy down the interest rate thereby lowering future cash outlays associated with the periodic loan payments 120. In some scenarios, buying down the interest rate of the collateralized premium finance loan 216 decreases or eliminates loan costs that would otherwise be passed on to the individual's heirs. Such a feature potentially increases a percentage of the proceeds 110 actually obtained by the heirs.

For purposes of explanation, consider a hypothetical example that includes rate buy down of the premium finance loan 216. In this example, the individual 102 desires to control cash flow utilizing premium finance loan 216. However, the individual is uncomfortable with the interest rate proposed by lender 114. In this case the individual sees the premium finance loan 216 as a useful tool in his/her financial planning, but is not comfortable with the proposed interest rate. The rate buy down feature 122 allows the individual to adjust the amount of the loan payments going forward. So for x amount of money today, the individual can buy down the interest rate component of payments 120 for a period of time. In a further example, the individual may also have liquidity available now and does not want to pay interest going forward. Accordingly, the individual can pay amount x now so that there is not interest rate component (or a decreased interest rate component) of payments 120 for an agreed upon period of time. After the period of time the interest rate component may resume. As mentioned above, in some scenarios the rate buy down feature 122 of the premium finance loan 216 can enhance the net benefit left to the individual's heirs from the life insurance policy 104. For instance, lacking the rate buy down feature 122, the interest payments may be taken out of the life insurance policy proceeds 110. Stated another way, the costs of the premium finance loan 216 will ultimately net against the proceeds 110 of the life insurance policy 104 unless they are already paid.

Various incentives can be created to entice lender 114 to offer the rate buy down feature 122 of premium finance loan 216. In some instances, the lender can charge disbursement fees toward undrawn amounts of periodic disbursements (i.e., disbursements to cover premiums 108) of the loan and/or can charge a pre-payment penalty against undrawn principal of the loan. For instance, the lender can charge an unused disbursement fee that is charged to any undrawn amount of a periodic disbursement of the premium finance loan 216. In some instances the disbursement fee is not charged where the undrawn amount is less than a predefined percent of a scheduled amount. The disbursement fee can be charged periodically until the entire loan amount is drawn. In some implementations, the unused disbursement fee cannot be capitalized or deferred.

FIG. 3 shows a system 300 that builds upon the life insurance policy loan collateralization introduced above in relation to FIGS. 1 and 2. For ease of explanation in the implementations described above in relation to FIGS. 1 and 2, the individual takes out the life insurance policy, the collateralized loan, and can pay down the interest on the collateralized loan. FIG. 3 introduces scenarios involving entities other than the individual assuming some of these roles. For instance, in some cases, individual 102 forms an irrevocable life insurance trust (“IT”) 302. Either of the IT 302, or the individual 102, purchases the life insurance policy 104. Similarly, either of the IT or the individual takes out the premium finance loan 214.

The IT 302 offers an estate planning tool that may be beneficial in certain scenarios. For instance, utilizing the IT to purchase the life insurance policy 104 and take out the premium finance loan 216 can serve to separate any assets obtained from the life insurance policy 104 from the individual's estate. In such a scenario where the IT 302 is both the policy holder of the insurance policy 104 and the borrower in relation to the premium finance loan 216 then the costs of the loan are netted against the end proceeds of the life insurance policy that go to the insured's estate. The individual 102 and/or the IT 302 can buy down the interest rate of the premium finance loan 216 to increase the percentage of the life insurance policy proceeds 110 that is actually retained by the IT after the lender 114 subtracts any owed fees. After the lump sum buy down 122, the IT 302 is responsible for the loan payments 120, although the lender 114 may have recourse to the family estate in the event of non-payment or default.

In some cases, the individual 102 can set up the IT 302. The IT then takes out the premium finance loan 216. The individual can give money to the IT as a gift that can be utilized to buy down the rate (i.e., rate buy down 122) of the premium finance loan 216 taken out by the IT 302. In such a scenario, the individual's gift to the IT may be taxable but may decrease an amount of interest rate charges that would be subtracted from the proceeds 110 of the life insurance policy 104 to cover the interest portion of payment 120 on the premium finance loan 216. The end result of such a scenario may be that the individual 102 increases the net value received by the IT 302 from the proceeds 110 of the life insurance policy 104. In still another scenario, the individual or a family estate may loan money to the IT to cover the rate buy down of the premium finance loan thereby further diminishing potential tax consequences. In still other cases, the lender 114 may act as a trustee to IT 302. In such cases the lender may periodically charge a trustee fee against the IT.

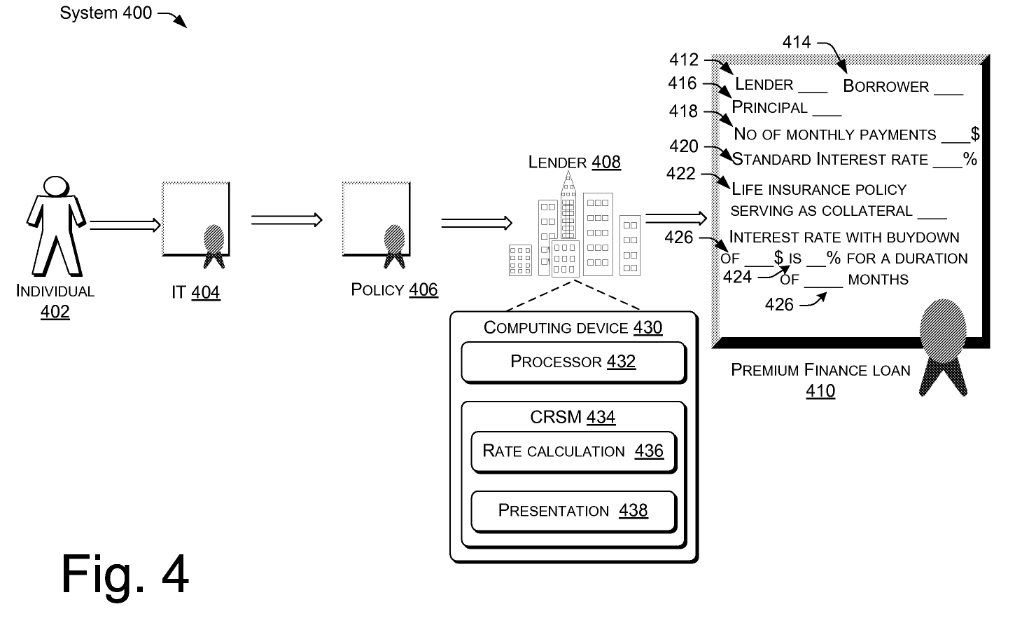

FIG. 4 shows another system 400 that involves life insurance policy loan collateralization with the option of a rate buy down. In this case, individual 402 forms an IT 404. The IT takes out a life insurance policy 406 on the individual. The IT 404 further approaches a lender 408 for a premium finance loan to fund the premiums. In this case, the premium finance loan is represented as premium finance loan agreement 410. Premium finance loan or premium finance loan agreement 410 can first be presented as a “loan offer”. The loan offer can become a loan agreement at such time as the lender 408 and borrower (i.e., the IT 404 agree to the conditions of the loan and provide acceptable consideration.)

Premium finance loan 410 or premium finance loan agreement may include many or all of the elements present in a traditional loan agreement. For instance, premium finance loan agreement 410 identifies the lender and borrower at 412 and 414 respectively. The premium finance loan agreement also identifies the principal or loan amount at 416, the number of monthly payments at 418, a standard interest rate at 420, and a life insurance policy serving as collateral for the loan at 422. The premium finance loan agreement can contain other information such as the age of the individual, the state in which the IT exists, the state in which the life insurance policy exists, etc.

The premium finance loan agreement 410 can further include an alternative interest rate 424 with a rate buy down 426 of a given amount for a given duration 428. While a single example of a rate buy down is represented here, the premium finance loan agreement (or offer) may include several rate buy down options. For instance, a lump sum payment of “a” results in an interest rate of “x”, a lump sum payment of “b” results in an interest rate of “y” and a lump sum payment of “c” results in an interest rate of “z”. In some implementations, the individual 402 or IT 404 can pay the lump sum as a condition of making the premium finance loan. In other cases, the lump sum can be paid within an agreed upon time after the premium finance loan goes into affect to achieve the reduced or alternative interest rate.

The lender 408 can employ one or more computing devices 430 to perform various functions relating to producing premium finance loan 410. The computing device 430 can employ a processor(s) 432 to execute computer readable instructions that are stored on a computer readable storage media (CRSM) 434. In some cases the instructions on computer readable storage media 434 can be manifested as a rate calculation module 436 and a presentation module 438. The rate calculation module can calculate the standard interest rate 420 and the alternative interest rate 424. The calculation module 436 can handle various calculation scenarios. For instance, the borrower may want to see what interest rate buy downs are achieved with various lump sum amounts. Another borrower may be interested in specific percentage interest rate drops and may want to see the corresponding lump sum payment amounts. Presentation module 438 can format the calculated interest rates and corresponding lump sum amounts as well as other loan data in a human perceptible format such as the illustrated premium finance loan agreement 410.

Operation

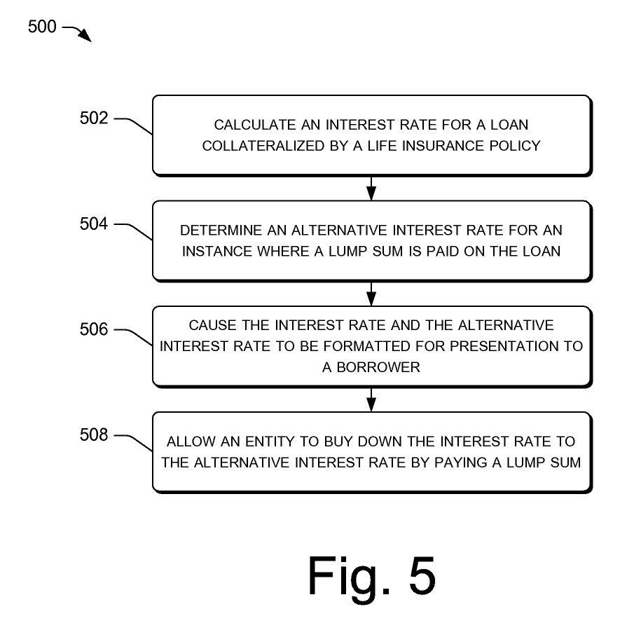

FIG. 5 illustrates an exemplary flow diagram of a process or method 500 for implementing the collateralized loan structure described above. For ease of explanation, the process is described utilizing the terms lender and borrower introduced above. Process 500 is illustrated as a collection of blocks in a logical flow graph, which represent operations that can be implemented in hardware, software, or a combination thereof. All processes described throughout this document may similarly comprise operations that can be implemented in hardware, software, or a combination thereof. In the context of software, the blocks represent computer-executable instructions that, when executed by one or more processors, perform the recited operations. Generally, computer-executable instructions include routines, programs, objects, components, data structures, and the like that perform particular functions or implement particular abstract data types. In one case, the method is stored on a computer-readable storage media as a set of instructions such that execution by a computing device causes the computing device to perform the method. The order in which the operations are described is not intended to be construed as a limitation, and any number of the described blocks can be combined in any order and/or in parallel to implement the present concepts.

Process 500 calculates an interest rate for a loan collateralized by a life insurance policy at 502. The process can also calculate other terms and conditions, such as the term of the loan, among others. In some instances, the loan is a premium finance loan to cover the cost of premiums of the life insurance policy. In these cases, the principal of the loan can be dispensed either periodically or otherwise paid to the borrower or directly to an insurance provider to cover the premiums. In some instances, the loan interest rate can be calculated utilizing various data tables, algorithms, or other mechanisms stored on a computer readable storage media.

The process determines an alternative interest rate for an instance where a lump sum is paid on the loan at 504. In some cases multiple alternative interest rates can be determined that correspond to differing lump sum values. For instance, a relatively higher value lump sum payment may correspond to a relatively lower interest rate (i.e., a bigger rate buy down) than a relatively lower value lump sum. For example, in a hypothetical case, a $20,000 lump sum payment can buy down the interest rate farther than a $10,000 lump sum payment. The alternative interest rate can be calculated for an entire duration of the collateralized loan or a portion thereof. Thus, continuing with the above example, in one scenario the $10,000 lump sum payment and the $20,000 lump sum payment can both buy down the interest rate four percentage points. However, the lesser $10,000 amount, may buy down the interest rate for 10 years while the greater $20,000 amount buys down the interest rate for 20 years.

The process causes the interest rate and the alternative interest to be formatted for presentation to a borrower at 506. The borrower can be any entity interested in the loan. For instance, the borrower can be the insured individual (i.e., the individual upon which the life insurance policy is taken out). In another instance, the borrower can be an irrevocable life insurance trust (IT) formed by the individual. In some implementations the process finalizes the loan. The finalized loan can list the conditions of the loan as agreed upon by the lender and borrower. In some cases the finalized loan can list the interest rate buy down options that are available to the borrower. In other instances, the finalized loan can include only a single rate buy down option that was agreed upon by the lender and borrower.

The process allows an entity to buy down the interest rate to the alternative interest rate by paying a lump sum at 508. The entity may or may not be the borrower. For example, in one hypothetical example the IT may be the borrower, but the individual may buy down the interest rate.

The entity may buy down the interest by paying the lump sum as part of the loan finalization process. In other instances, the lump sum may be paid after the loan is finalized. For instance, the loan conditions may state that the lump sum can be paid within an agreed upon period of time, such as 30 days, to buy down the loan to the alternative interest rate.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable storage media comprising computer-executable instructions that, when executed perform acts comprising:
calculating an interest rate for a loan to fund premiums of a life insurance policy on an individual; and,
allowing an entity to buy down the interest rate by paying a lump sum.

2. The computer-readable storage media of claim 1, wherein the calculating comprises calculating the interest rate, and at least one alternative interest rate associated with the lump sum buy down.

3. The computer-readable storage media of claim 1, wherein the allowing comprises allowing an entity to buy down the interest rate for one of: a life of the loan and a predetermined period.

4. The computer-readable storage media of claim 1, wherein the allowing comprises one of: allowing an entity to buy down a number of points of the interest rate to reduce the interest rate and allowing an entity to buy down a number of points sufficient to eliminate the interest rate.

5. The computer-readable storage media of claim 1, wherein the allowing an entity comprises allowing the individual to buy down the interest rate.

6. The computer-readable storage media of claim 1, wherein in an instance where the individual has established an irrevocable life insurance trust (IT), the allowing an entity comprises allowing one or more of: the individual and the IT to buy down the interest rate.

7. The computer-readable storage media of claim 6, further comprising periodically charging a trustee fee against the IT.

8. The computer-readable storage media of claim 1, further comprising verifying an existence of the life insurance policy.

9. The computer-readable storage media of claim 1, further comprising monitoring a value of the life insurance policy.

10. The computer-readable storage media of claim 9, further comprising, in an instance where said monitoring determines that the value is below a predetermined variation margin, then requesting additional collateral for the loan.

11. The computer-readable storage media of claim 10, further comprising in an instance where the requested additional collateral is not received within a predefined period then placing the loan in default.

12. The computer-readable storage media of claim 1, further comprising charging an arrangement fee on the loan.

13. The computer-readable storage media of claim 1, further comprising charging disbursement fees toward undrawn amounts of periodic disbursements of the loan.

14. The computer-readable storage media of claim 1, further comprising charging a pre-payment penalty against undrawn principal of the loan.

15. The computer-readable storage media of claim 1, further comprising increasing the interest rate in at least some predefined instances where the loan is in default.

16. A method, comprising:
calculating an interest rate for a loan to fund premiums due on a life insurance policy; and,
determining an alternative interest rate for an instance where a lump sum is paid on the loan; and,
causing the interest rate and the alternative interest rate to be formatted for presentation to a borrower.

17. The method of claim 16, wherein the calculating comprises one of: calculating an interest rate that is fixed for a duration of the loan and calculating an interest rate that includes a base rate and which can vary relative to the base rate.

18. The method of claim 16, wherein the causing comprises causing the interest rate and the alternative interest rate with the corresponding lump sum to be included on a loan offer document.

19. The method of claim 16, further comprising allowing the borrower to select between the interest rate and the alternative interest rate with the corresponding lump sum.

20. A computing system configured to execute instructions directed to a method, comprising:
verifying an existence of a life insurance policy for an individual that issues to an irrevocable life insurance trust (IT);
calculating an interest rate for a loan to the IT wherein the loan is collateralized by the life insurance policy;
formalizing the loan; and,
allowing one of the individual and the IT to buy down the interest rate by paying a lump sum.

21. The method of claim 20, wherein the formalizing comprises presenting a listing of the interest rate and at least one alternative interest rate that reflects the rate buy down in a user-perceptible form.

22. The method of claim 20, wherein the formalizing comprises making the loan.

23. The method of claim 20, wherein the allowing comprises allowing the individual or the IT to buy down the loan for a period of less than a duration of the loan or an entire duration of the loan.

24. The method of claim 23, wherein the allowing occurs either before or after disbursement of funds of the loan.

25. A computing system, comprising:
a rate calculation module for calculating an interest rate for a loan collateralized by a life insurance policy and for calculating at least one alternative interest rate for an instance where a lump sum is paid on the loan; and,
a presentation module for formatting the interest rate and the alternative interest rate for presentation to a borrower.
